(19) United States
(12) Patent Application Publication
(10) Pub. No.: US 2022/0309258 A1
(43) Pub. Date: Sep. 29, 2022

(54) METHODS AND APPARATUSES FOR DETERRING UNAUTHORIZED RFID SCANNERS

(71) Applicant: Sensormatic Electronics, LLC, (US)

(72) Inventor: Steven J. RAYNESFORD, Mission Viejo, CA (US)

(21) Appl. No.: 17/701,241

(22) Filed: Mar. 22, 2022

Related U.S. Application Data
(60) Provisional application No. 63/165,527, filed on Mar. 24, 2021.

(51) Int. Cl. G06K 7/00; G06K 7/10; G06K 19/07

(52) U.S. Cl. CPC G06K 7/0008; G06K 7/10366; G06K 7/10316; G06K 19/0723

(57) ABSTRACT

Aspects of the present disclosure include receiving one or more RFID interrogating signals from the RFID scanner, generating one or more internal signals, mixing the one or more RFID interrogating signals with the one or more internal signals to generate one or more resultant signals, and backscattering the one or more resultant signals.

### CROSS-REFERENCE TO RELATED APPLICATIONS

The current application claims priority to, and the benefit of, U.S. Provisional Application No. 63/165,527 filed on Mar. 24, 2021, entitled “METHODS AND APPARATUSES FOR DETERRING UNAUTHORIZED RFID SCANNERS,” the contents of which are hereby incorporated by reference in their entireties.

### BACKGROUND

A retail store may encounter loss due to theft, fraud, or mistakes. For example, a thief may enter the retail store with an radio frequency identification (RFID) scanner in order to read, obtain, and/or alter information stored in one or more RFID tags associated with merchandize items in the retail store. While it may be possible to utilize protective measures in the RFID tags to deter the unauthorized use of RFID scanners, these protective measures may increase the cost of the RFID tags. Therefore, improvements in deterring the unauthorized use of RFID scanners is desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include receiving one or more RFID interrogating signals from an RFID scanner, generating one or more internal signals, mixing the one or more RFID interrogating signals with the one or more internal signals to generate one or more resultant signals, and backscattering the one or more resultant signals.

Aspects of the present disclosure include an access-control system (ACS) having an antenna configured to receive one or more radio frequency identification (RFID) interrogating signals from an RFID scanner, a circulator configured to receive the one or more RFID interrogating signals from the antenna via a first terminal and providing the one or more RFID interrogating signals to a mixer via a second terminal, a generator configured to generate one or more internal signals and provide the one or more internal signals to the mixer, the mixer configured to receive the one or more RFID interrogating signals, receive the one or more internal signals, mix the one or more RFID interrogating signals and the one or more internal signals to generate one or more resultant signals, and backscatter the one or more resultant signals via the antenna.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for utilizing an access control system in accordance with aspects of the present disclosure;

FIG. 2 illustrates an example of a method for backscattering one or more modified RFID interrogating signals to an RFID scanner in accordance with aspects of the present disclosure; and

FIG. 3 illustrates an example of a computer system in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

Aspects of the present disclosure may include an access-control system (ACS) for deterring and/or disrupting unauthorized use of a radio frequency identification (RFID) scanner in a retail store. The unauthorized RFID scanning may be used by a thief to read, obtain, and/or alter information stored in one or more RFID tags attached to merchandize items in the retail store. In an aspect, a thief may cause the RFID scanner to transmit one or more interrogating signals via the RFID scanner to read the contents of a RFID tag in the retail store. The ACS may receive the one or more unauthorized interrogating signals from the RFID scanner. The ACS may generate one or more internal signals via a generator. The ACS may mix the one or more interrogating signals and the one or more internal signals to generate one or more resultant signals. The ACS may backscatter the one or more resultant signals to the originating RFID scanner. Since the one or more resultant signals has been modified by the one or more internal signals, the originating RFID scanner may be unable to properly read the contents of any responding RFID tags in the vicinity and the unauthorized access is prevented.

In one aspect of the present disclosure, the ACS may restrict access to the RFID tag during a first time. Specifically, the ACS may be activated during the first time to backscatter the one or more resultant signals to the interrogating RFID scanner. The ACS may be disabled during a second time to permit access to the RFID tag. In a retail environment, a RFID scanner used by, for example, store personnel, may synchronize the access to the RFID tag with the ACS. In particular, the RFID scanner used by the store personnel may access the RFID tag during the second time when the ACS is disabled.

In certain aspects of the present disclosure, the ACS provides a “window” of time that RFID scanners may access the RFID tags. This window may be synchronized with “authorized” RFID scanners such that the authorized RFID scanners may access the RFID tags during the window. “Unauthorized” RFID scanner may be unaware of the window and may attempt to access the RFID tags outside of the window.

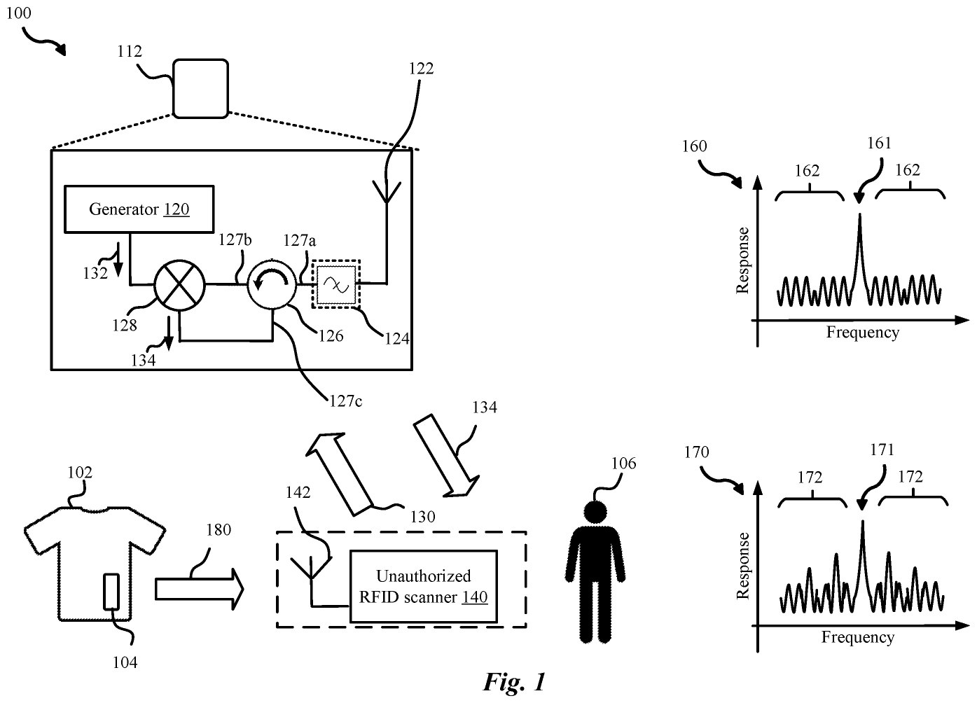

Referring to FIG. 1, in a non-limiting implementation, an example of an environment 100 (e.g., a retail store) for deterring the unauthorized access of information stored in a RFID tag 104 attached to a merchandise item 102. An unauthorized person 106 may utilize an RFID scanner 140 and/or the scanner antenna 142 to access (e.g., read, store, and/or alter) information in the RFID tag 104. For example, the information in the RFID tag 104 may include item information, size information, inventory information, etc. The unauthorized person 106 may attempt to alter the item code of the merchandize item 102 from a higher priced item to the code of a lower priced item.

In one aspect of the present disclosure, the environment 100 may include an access-control system (ACS) 112 configured to backscatter unauthorized RFID interrogating signals. The ACS 112 may include a generator 120 that generates internal signals as described below. The generator 120 may be configured to generate a sinusoidal wave, a square wave, a triangular wave, a step wave, or other types of waveforms. The generator 120 may be configured to generate internal signals at various frequencies (e.g., 10 kilohertz to 1 megahertz).

In some implementations, the ACS 112 may include an antenna 122 configured to receive RFID interrogating signals (authorized and/or unauthorized). In some aspects, the ACS 112 may be placed on a shelf, attached to a fixture, placed on the floor of the retail store, etc. The ACS 112 may include an optional filter 124 configured to filter the received RFID interrogating signals. The optional filter 124 may be a low pass filter, a high pass filter, a band pass filter, an intensity filter, or other suitable filters. The optional filter 124 may include one or more amplifiers configured to amplify the received RFID interrogating signals. The ACS 112 may include a circulator 126 having a first terminal 127a, a second terminal 127b, and a third terminal 127c. In one implementation, signals received at the first terminal 127a may be relayed to the second terminal 127b. Signals received at the second terminal 127b may be relayed to the third terminal 127c. Signals received at the third terminal 127c may be relayed to the first terminal 127a. Other suitable configurations may also be implemented. The ACS 112 may include a mixer 128 configured to mix signals received from the generator 120 and signals received from the circulator 126 to generate one or more resultant signals to be backscattered via the antenna 122.

In an alternative implementation, the ACS 112 may include a first antenna and a second antenna. The first antenna (used for reception) may be connected to an input port of the mixer 128 and the second antenna (used for transmission) may be connected to an output port of the mixer 128. An amplifier may be added to the second antenna.

In an alternative implementation, the ACS 112 may include a reflective modulator (not shown) instead of the circulator 126 and the mixer 128. The reflective modulator may include a varactor that changes and/or modulate the received signals.

During operation, in some aspects of the present disclosure, the RFID scanner 140 may transmit one or more RFID interrogating signals 130 to access the information stored in the RFID tag 104. The antenna 122 of the ACS 112 may receive the one or more RFID interrogating signals 130. The one or more RFID interrogating signals 130 may enter the first terminal 127a of the circulator 126. The circulator 126 may relay the one or more RFID interrogating signals 130 from the first terminal 127a to the second terminal 127b.

In some implementations, the generator 120 may generate one or more internal signals 132. The one or more internal signals 132 may be a sinusoidal wave, a square wave, a triangular wave, a step wave, or other types of waveforms or combinations of waveforms. The one or more internal signals 132 may have a frequency between 10 kHz to 1 MHz. In one aspect, the frequency range of the one or more internal signals 132 may be tailored to match the response frequency of the RFID tag 104.

In an implementation, the mixer 128 may receive the one or more internal signals 132 from the generator 120 and the one or more RFID interrogating signals 130 from the circulator 126 (via the second terminal 127b). The mixer 128 may mix the one or more internal signals 132 and the one or more RFID interrogating signals 130 to generate one or more resultant signals 134. The mixer 128 may relay the one or more resultant signals 134 into the third terminal 127c of the circulator 126. The circulator 126 may relay the one or more resultant signals 134 from the third terminal 127c to the first terminal 127a. The antenna 122 may propagate the one or more resultant signals 134.

In some implementations, the RFID tag 104 may backscatter response signals 180, having a first frequency response 160, in response to the one or more RFID interrogating signals 130. The first frequency response 160 may include a carrier signal 161 and information signals 162. The information signals 162 may carry information stored in the RFID tag 104 as described above.

In some implementations, the ACS 112 may receive the RFID interrogating signals 130 and backscatter the one or more resultant signals 134 having a second frequency response 170. The second frequency response 170 may include a carrier signal 171 and sideband signals 172. The sideband signals 172 may mask the information signals 162 of the response signals 180 backscattered by the RFID tag 104. As a result, the RFID scanner 140 may be unable to properly access the information in the RFID tag 104.

In an aspect, the mixer 128 may modulate the one or more internal signals 132 and the one or more unauthorized RFID interrogating signals 130.

In an aspect, the one or more resultant signals 134 may have higher or lower amplitudes than the one or more unauthorized RFID interrogating signals 130.

In an aspect, the antenna 122 may be used for receiving the one or more RFID interrogating signals 130 and for backscattering the one or more resultant signals 134. In other aspects, different antennas may be used.

In some aspects, some or all of the ACS 112 may be selectively disabled to enable an RFID scanner (not shown) to access the information in the RFID tag 104. For example, the generator 120 may be disabled during the transmission of one or more RFID interrogating signals. The generator 120 may be disabled in response to receiving an indication to disable the generation of the one or more internal signals 132. The indication may be provided by an indication signal transmitted by an authorized RFID scanner, a physical switch associated with the generator 120, or other appropriate means. The ACS 112 may be disabled for a certain amount of time, e.g., sufficient time for an authorized RFID scanner to access the RFID tag 104.

In some aspects, the ACS 112 may be configured to determine a direction of reception of the one or more RFID interrogating signals 130 from the RFID scanner 140 and direct (e.g., physically and/or electronically) the one or more resultant signals toward the direction.

In some aspects, the antenna gain peak frequency of antenna 122 may be adjustable to a specific frequency band.

In some aspects, the ACS 112 may be configured to receive signals on specific frequencies (e.g., using fixed and/or tunable filters, and/or antenna tuning) and reject signals on other frequencies.

In certain aspects, the ACS 112 may be configured to act on received signals exceeding a threshold received power level and reject signals below the threshold received power level.

In some aspects, the ACS 112 may be configured to backscatter the one or more resultant signals 134 in response to signals originating from a specific direction.

In some aspects, the ACS 112 may be configured to control gain of the one or more resultant signals 134.

In certain aspects, the ACS 112 may be configured to control and/or select backscatter side-band signal parameters. Side-band signals may signals that are carried by the carrier wave. The side-band signals may optionally be configured to encode data.

In certain aspects, the ACS 112 may be configured to generate an alert in response to receiving the one or more RFID interrogating signals 130. The alert may include information indicating which ACS 112 (if more than one) generated the alert to indicate the proximity of the RFID scanner. The alert may include information on the ACS mode of operation, including if the internal signal generator is active or inactive.

In some aspects, the ACS 112 may be configured to modulate and/or encode data in the backscattered side-band signals. The backscattered side-band signals of the ACS 112 may have no correlation to the response signals 180 of the RFID tag 104. Alternatively, the backscattered side-band signals of the ACS 112 may be correlated with the response signals 180 of the RFID tag 104.

In certain aspects, the ACS backscattered side-bands may include a single signal or a number of uncorrelated signals.

In some aspects, the ACS backscattered side-band data may be fixed and/or determined according to information available to the ACS 112.

In some implementations, more than one ACS 112 may be placed in the retail store. Each ACS 112 may be associated with a zone. Depending on the location of the particular ACS 112 that backscatters signals due to RFID interrogating signals of an RFID scanner, it may be possible to identify the zone that the RFID scanner is transmitting from. This location information may be provided to security personnel of the retail store to locate a thief or a misconfigured RFID scanner.

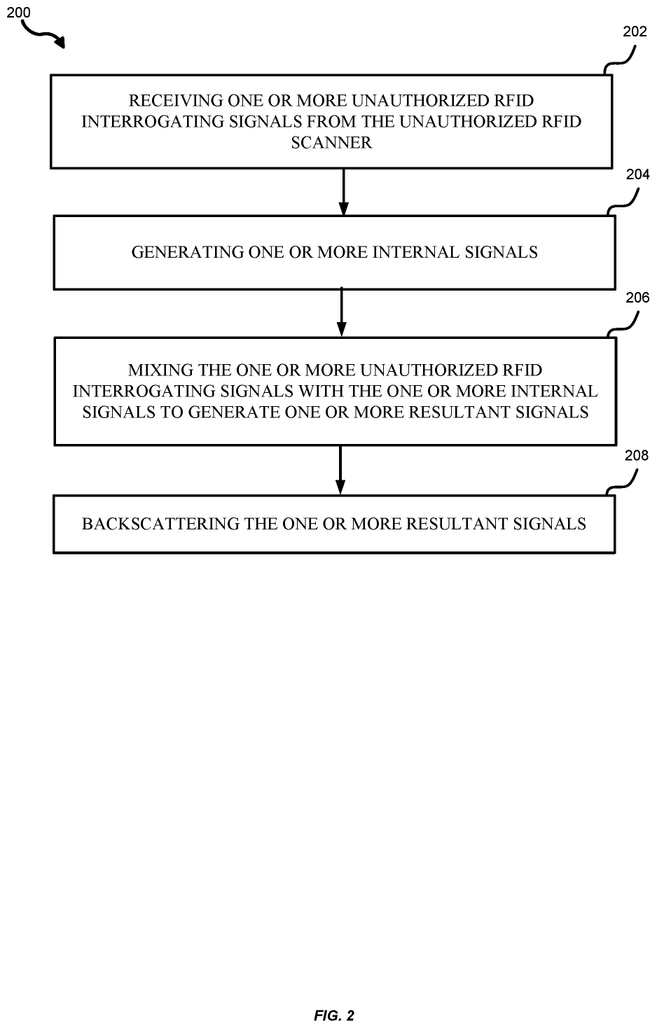

Turning to FIG. 2, an example of a method 200 for backscattering one or more RFID interrogating signals to an RFID scanner. Specifically, the method 200 may be performed by one or more of the generator 120, the antenna 122, the circulator 126, and/or the mixer 128 of the ACS 112.

At block 202, the method 200 may receive one or more FID interrogating signals from an RFID scanner. For example, the antenna 122 and/or the circulator 126 of the ACS 112 may receive one or more RFID interrogating signals from the RFID scanner as described above. The antenna 122 and/or the circulator 126 of the ACS 112 may be configured to and/or define means for receiving one or more RFID interrogating signals 130 from the RFID scanner 140.

At block 204, the method 200 may generate one or more internal signals. For example, the generator 120 of the ACS 112 may generate one or more internal signals 132 as described above. The generator 120 and/or the ACS 112 may be configured to and/or define means for generating one or more internal signals.

At block 206, the method 200 may mix the one or more RFID interrogating signals with the one or more internal signals to generate one or more resultant signals. For example, the mixer 128 of the ACS 112 may mix the one or more RFID interrogating signals 130 with the one or more internal signals 132 to generate the one or more resultant signals 134 as described above. The mixer 128 of the ACS 112 may be configured to and/or define means for mixing the one or more RFID interrogating signals with the one or more internal signals to generate one or more resultant signals.

At block 208, the method 200 may backscatter the one or more resultant signals. For example, the antenna 122 and/or the circulator 126 may backscatter the one or more resultant signals 134 as described above. The antenna 122 and/or the circulator 126 of the ACS 112 may be configured to and/or define means for backscattering the one or more resultant signals.

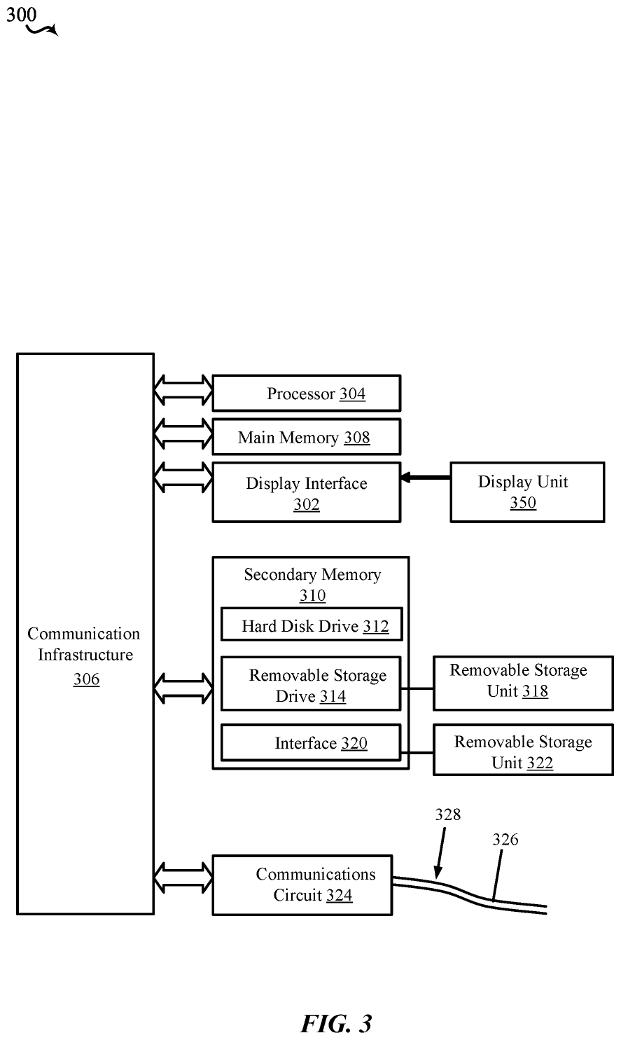

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 300 is shown in FIG. 3. In some examples, the generator 120, a portion of the ACS 112, and/or the ACS 112 may be implemented as the computer system 300 shown in FIG. 3. The generator 120 and/or the ACS 112 may include some or all of the components of the computer system 300.

The computer system 300 includes one or more processors, such as processor 304. The processor 304 is connected with a communication infrastructure 306 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 300 may include a display interface 302 that forwards graphics, text, and other data from the communication infrastructure 306 (or from a frame buffer not shown) for display on a display unit 350. Computer system 300 also includes a main memory 308, preferably random access memory (RAM), and may also include a secondary memory 310. The secondary memory 310 may include, for example, a hard disk drive 312, and/or a removable storage drive 314, representing a floppy disk drive, a magnetic tape drive, an optical disk drive, a universal serial bus (USB) flash drive, etc. The removable storage drive 314 reads from and/or writes to a removable storage unit 318 in a well-known manner. Removable storage unit 318 represents a floppy disk, magnetic tape, optical disk, USB flash drive etc., which is read by and written to removable storage drive 314. As will be appreciated, the removable storage unit 318 includes a computer usable storage medium having stored therein computer software and/or data. In some examples, one or more of the main memory 308, the secondary memory 310, the removable storage unit 318, and/or the removable storage unit 322 may be a non-transitory memory.

Alternative aspects of the present disclosures may include secondary memory 310 and may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and the removable storage unit 322 and the interface 320, which allow software and data to be transferred from the removable storage unit 322 to computer system 300.

Computer system 300 may also include a communications circuit 324. The communications circuit 324 may allow software and data to be transferred between computer system 300 and external devices. Examples of the communications circuit 324 may include a modem, a network interface (such as an Ethernet card), a communications port, a Personal Computer Memory Card International Association (PCMCIA) slot and card, etc. Software and data transferred via the communications circuit 324 are in the form of signals 328, which may be electronic, electromagnetic, optical or other signals capable of being received by the communications circuit 324. These signals 328 are provided to the communications circuit 324 via a communications path (e.g., channel) 326. This path 326 carries signals 328 and may be implemented using wire or cable, fiber optics, a telephone line, a cellular link, an RF link and/or other communications channels. In this document, the terms “computer program medium” and “computer usable medium” are used to refer generally to media such as the removable storage unit 318, a hard disk installed in hard disk drive 312, and signals 328. These computer program products provide software to the computer system 300. Aspects of the present disclosures are directed to such computer program products.

Computer programs (also referred to as computer control logic) are stored in main memory 308 and/or secondary memory 310. Computer programs may also be received via communications circuit 324. Such computer programs, when executed, enable the computer system 300 to perform the features in accordance with aspects of the present disclosures, as discussed herein. In particular, the computer programs, when executed, enable the processor 304 to perform the features in accordance with aspects of the present disclosures. Accordingly, such computer programs represent controllers of the computer system 300.

In an aspect of the present disclosures where the method is partially or fully implemented using software, the software may be stored in a computer program product and loaded into computer system 300 using removable storage drive 314, hard disk drive 312, or the interface 320. The control logic (software), when executed by the processor 304, causes the processor 304 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method for deterring a radio frequency identification (RFID) scanner, comprising:
receiving one or more RFID interrogating signals from the RFID scanner;
generating one or more internal signals;
mixing the one or more RFID interrogating signals with the one or more internal signals to generate one or more resultant signals; and
backscattering the one or more resultant signals.

2. The method of claim 1, further comprising:
receiving an indication indicating an incoming transmission of a second RFID interrogating signal by a second RFID scanner;
receiving the second RFID interrogating signal; and
propagating the second RFID interrogating signal without mixing the second RFID interrogating signal with a second internal signal.

3. The method of claim 1, further comprising:
determining a direction of reception of the one or more RFID interrogating signals from the RFID scanner;
wherein the backscattering comprises directing the one or more resultant signals toward the direction.

4. The method of claim 1, further comprising adjusting one or more frequencies or one or more amplitudes of the one or more internal signals prior to generating the one or more internal signals.

5. The method of claim 1, further comprising filtering the one or more received RFID interrogating signals.

6. The method of claim 1, further comprising generating an alert in response to backscattering the one or more resultant signals.

7. The method of claim 1, wherein generating the one or more internal signals comprises encoding data into the one or more internal signals.

8. The method of claim 1, wherein generating the one or more internal signals comprises:
generating the one or more internal signals during a first period of time, and
refraining from generating the one or more internal signals during a second period of time.

9. The method of claim 8, further comprising:
receiving the one or more RFID interrogating signals during the second period of time; and
backscattering the one or more RFID interrogating signals without mixing the one or more RFID interrogating signals with the one or more internal signals.

10. An access-control system (ACS), comprising:
an antenna configured to receive one or more unauthorized radio frequency identification (RFID) interrogating signals from an unauthorized RFID scanner;
a circulator configured to:
receive the one or more unauthorized RFID interrogating signals from the antenna via a first terminal, and
provide the one or more unauthorized RFID interrogating signals to a mixer via a second terminal;
a generator configured to:
generate one or more internal signals, and
provide the one or more internal signals to the mixer; and
the mixer configured to:
receive the one or more unauthorized RFID interrogating signals,
receive the one or more internal signals,
mix the one or more unauthorized RFID interrogating signals and the one or more internal signals to generate one or more resultant signals, and
backscatter the one or more resultant signals via the antenna.

11. The ACS of claim 10, wherein:
the generator is further configured to receive an indication indicating an incoming transmission of a second RFID interrogating signal by a second RFID scanner; and
the ACS is configured to:
receive the second RFID interrogating signal, and
propagate the second RFID interrogating signal without mixing the second RFID interrogating signal with a second signal.

12. The ACS of claim 10, wherein:
the ACS is configured to determine a direction of reception of the RFID interrogating signals from the unauthorized RFID scanner;
the antenna is further configured to direct the one or more resultant signals toward the direction.

13. The ACS of claim 10, wherein the generator is further configured to adjust one or more frequencies or one or more amplitudes of the one or more internal signals prior to generating the one or more internal signals.

14. The ACS of claim 10, further comprising a filter configured to filter the one or more received RFID interrogating signals.

15. The ACS of claim 10, further comprising generating an alert in response to backscattering the one or more resultant signals.

16. The ACS of claim 10, wherein generating the one or more internal signals comprises encoding data into the one or more internal signals.

17. The ACS of claim 10, wherein generating the one or more internal signals comprises:
generating the one or more internal signals during a first period of time, and
refraining from generating the one or more internal signals during a second period of time.

18. The ACS of claim 17, wherein the ACS is further configured to:
receive one or more authorized RFID interrogating signals during the second period of time; and
backscatter the one or more authorized RFID interrogating signals without mixing the one or more authorized RFID interrogating signals with the one or more internal signals.
